(19) United States
(12) Patent Application Publication
(10) Pub. No.: US 2026/0269683 A1
(43) Pub. Date: Sep. 10, 2026

(54) BRAKE ASSEMBLY FOR MOTORS

(71) Applicant: NEUROMEKA CO., LTD., Seoul (KR)

(72) Inventors: Jong Hoon PARK, Seoul (KR); Yun Ho SHIN, Seoul (KR); Min Chul KIM, Seoul (KR); Ji Hun PARK, Seoul (KR)

(21) Appl. No.: 19/161,618

(22) PCT Filed: Mar. 5, 2024
(86) PCT No.: PCT/KR2024/002792

§ 371 Date: Sep. 2, 2025

(30) Foreign Application Priority Data
Mar. 7, 2023 (KR) 10-2023-0029947

(51) Int. Cl. H02K 7/102; H02K 7/12

(52) U.S. Cl. CPC H02K 7/102; H02K 7/12; H02K 2213/06

(57) ABSTRACT

A brake assembly for motors, having a stator and a rotor, according to the present invention comprises: a switching disk that rotates with the same rotation axis as that of the rotor and selectively provides braking friction with respect to one of the stator and the rotor; a pin brake unit that reciprocates along the direction of the rotation axis of the rotor and the switching disk and limits the rotational movement of either the rotor or the switching disk; and an actuator that is connected to the pin brake unit and provides a driving force to the pin brake unit so as to selectively provide braking friction with respect to one of the stator and the rotor via the switching disk depending on whether current is supplied.

### TECHNICAL FIELD

The present disclosure relates to a brake assembly for a motor, and more particularly, to a brake assembly for a motor that generates at least one of braking frictional force and brake torque to stop rotational motion of a rotor that is a rotating body constituting the motor.

### BACKGROUND ART

Brakes are used to stop rotational motion of rotating bodies. For example, there are a brake to stop rotational motion of car wheels, a brake to stop rotational motion of bicycle wheels, and a brake to stop rotational motion of a rotor is a rotating body of a motor. Typical methods of stopping rotating bodies are classified into a mechanical friction method and a method that generates brake torque by a medium composed of particles.

In this case, the mechanical friction method uses a caliper disc brake and a drum brake. Further, the method that generates brake torque by a medium composed of particles includes a powder brake and Magneto-Rheological Fluid (MR fluid) brake. Specifically, a magneto-rheological fluid brake generates brake torque by varying the viscosity depending on whether a magnetic field is applied to the magneto-rheological fluid.

Motors are widely used in various fields, and recently they have become widely used in the robotics industry too, such as collaborative robots and industrial robots. A motor basically consists of a rotor, which is a rotating body, and a stator that provides rotational force to the rotor. A motor provides various driving methods using rotation and stopping of a rotor.

Meanwhile, motors that are used in the robotics field especially need to accurately perform driving and stopping. Further, the need for technology required to precisely stop the operation of a motor when current supply to the motor is interrupted due to a power outage or similar events occurring during motor operation in robots is increasing.

### DISCLOSURE

### Technical Problem

An objective of the present disclosure is to provide a brake assembly for a motor, the structure of which is improved to enable precise stopping of rotational motion of the rotor during driving of the motor.

Further, another objective of the present disclosure is to provide a brake assembly for a motor, the structure of which is improved to enable safe stopping of rotational motion of the rotor when a power outage occurs during driving of the motor.

### Technical Solution

The objectives described above are achieved by a brake assembly for a motor having a stator and a rotor in accordance with the present disclosure, the brake assembly including: a switching disc that is rotated with the same rotational axis as a rotational axis of the rotor and selectively provides braking frictional force between the switching disc and any one of the stator and the rotor; a pin brake unit that is reciprocally moved in the rotational axis direction of the rotor and the switching disc and restricts rotational motion of any one of the rotor and the switching disc; and an actuator that is connected to the pin brake unit and is operated to selectively provide braking frictional force between the pin brake unit and any one of the stator and the rotor by the switching disc depending on whether current is supplied.

Here, the brake assembly may further include: a magneto-rheological fluid (MR fluid) that is disposed between the rotor and the switching disc or between the stator and the switching disc, and selectively varies in viscosity to generate brake torque that stops rotational motion of the rotor; and magnet units that are respectively disposed on both sides with the magneto-rheological fluid therebetween, have different polarities when rotational motion of the rotor is restricted, and generate a magnetic field in the magneto-rheological fluid to induce a change in viscosity of the magneto-rheological fluid.

The pin brake unit may include: a pin brake that is reciprocally moved between a contact position where the pin brake is brought into contact with any one of the rotor and the switching disc when current supply to the actuator is interrupted and a contact release position where contact with any one of the rotor and the switching disc is released when current is supplied to the actuator; and an elastic member that disposed on one side of the pin brake in a reciprocating movement direction of the pin brake and provides elastic force to the pin brake so that the pin brake is moved from the contact release position to the contact position when current supply to the actuator is interrupted.

The pin brake unit may be disposed at the stator and reciprocally moved between the contact position where contact with the switching disc is made and the contact release position where contact is released, by operation of the actuator.

Rotational motion of the switching disc is restricted at the contact position, so braking frictional force between the rotor and the switching disc increases to stop the rotor.

The pin brake unit may be disposed at the switching disc and may be reciprocally moved between the contact position where contact with the rotor is made and the contact release position where contact is released, by operation of the actuator.

Braking frictional force between the stator and the switching disc may be increased to stop the rotor during coupled rotational motion of the rotor and the switching disc at the contact position.

The switching disc may be stopped at the contact release position and rotated in coupled relation with the rotor for a predetermined time at the contact position.

At least two pin brake units may be disposed, and the pin brake units may further include a stopper guide that has a ring shape, is disposed between the actuator and the pin brake, and guides movement of the pin brake and provides pressing force due to operation of the actuator to the pin brake when the switching disc is rotated, during coupled operation with rotational motion of the rotor.

Meanwhile, the objectives described above are achieved by a brake assembly for a motor having a stator and a rotor in accordance with the present disclosure, the brake assembly including: a pin brake unit that is disposed at the stator and selectively restricts rotational motion of the rotor by reciprocally moving in a rotational axis direction of the rotor; an actuator that is connected to the pin brake unit and selectively provides driving force to the pin brake so that the rotor and the pin brake unit are selectively brought into contact depending on whether current is supplied; and a backlash restriction unit that is disposed under the pin brake unit, and restricts reverse rotational motion of the rotor when rotational motion of the rotor is restricted by the pin brake unit.

Here, the rotor may be arranged with a plurality of blades, and the pin brake unit and the backlash restriction unit may be respectively brought into contact with both sides of the blades, thereby restricting rotational motion of the rotor in both directions.

The pin brake unit may include: a pin brake that is reciprocally moved between a contact position where the pin brake is brought into contact with the rotor when current supply to the actuator is interrupted and a contact release position where contact with the rotor is released when current is supplied to the actuator; and an elastic member that disposed on one side of the pin brake in a reciprocating movement direction of the pin brake and provides elastic force for movement from the contact release position of the pin brake to the contact position when current supply to the actuator is interrupted.

The backlash restriction unit may include: a body part that is disposed under the pin brake unit and moved in coupled relation with movement of the pin brake unit; a backlash restriction part that is rotatably connected to the body part and is brought into contact with the rotor when the pin brake unit is brought into contact the rotor, thereby restricting reverse rotational movement of the rotor; and a backlash restriction part elastic member that connects the body part and the backlash restriction part to each other and provides elastic force to the backlash restriction part so that the backlash restriction part is rotated in a direction in which the backlash restriction part is brought into contact with the rotor.

The details of other embodiments are included in the following detailed description and the accompanying drawings.

### Advantageous Effects

The effects of the brake assembly for a motor according to an embodiment of the present disclosure are as follows.

First, by selectively coming into contact with any one of the rotor and the switching disc using the pin brake, braking friction force is generated between the rotor and the switching disc or between the stator and the switching disc, whereby it is possible to ensure the operational safety of the motor even when current supply is interrupted, such as during a power outage.

Second, since it is possible to generate brake torque that depends on a change in viscosity of a magneto-rheological fluid by further disposing the magneto-rheological fluid between the rotor and the switching disc or between the stator and the switching disc, it is possible to ensure operation safety of the motor even when current supply is interrupted, such as during a power outage.

Third, since it is possible to accurately stop the rotor by disposing a backlash restriction unit that restricts rotation in the reverse direction of the rotational motion direction of the rotor when restricting rotational motion of the rotor by operating the pin brake unit, it is possible to improve the operational reliability of the motor.

### DESCRIPTION OF DRAWINGS

FIG. 1 is a first operational cross-sectional view of a brake assembly for a motor according to a first embodiment of the present disclosure.

FIG. 2 is a second operational cross-sectional view of a brake assembly for a motor according to the first embodiment of the present disclosure.

FIG. 3 is a first operational cross-sectional view of a brake assembly for a motor according to a second embodiment of the present disclosure.

FIG. 4 is a second operational cross-sectional view of a brake assembly for a motor according to the second embodiment of the present disclosure.

FIG. 5 is a first operational cross-sectional view of a brake assembly for a motor according to a third embodiment of the present disclosure.

FIG. 6 is a second operational cross-sectional view of a brake assembly for a motor according to the third embodiment of the present disclosure.

FIG. 7 is a first operational cross-sectional view of a brake assembly for a motor according to a fourth embodiment of the present disclosure.

FIG. 8 is a second operational cross-sectional view of a brake assembly for a motor according to the fourth embodiment of the present disclosure.

FIG. 9 is a first operational cross-sectional view of a brake assembly for a motor according to a fifth embodiment of the present disclosure.

FIG. 10 is a second operational cross-sectional view of a brake assembly for a motor according to the fifth embodiment of the present disclosure.

FIG. 11 is a plan view of a brake assembly for a motor according to a sixth embodiment of the present disclosure.

FIG. 12 is a first operational cross-sectional view of a brake assembly for a motor according to the sixth embodiment of the present disclosure.

FIG. 13 is a second operational cross-sectional view of a brake assembly for a motor according to the sixth embodiment of the present disclosure.

### MODE FOR INVENTION

Hereafter, brake assemblies for a motor according to embodiments of the present disclosure is described in detail with reference to the accompanying drawings.

Prior to the description, it should be noted in advance that the brake assemblies for a motor according to embodiments of the present disclosure are indicated by the same reference numerals for the same components.

Further, the brake assemblies for a motor according to embodiments of the present disclosure selectively provide braking frictional force between the switching disc and any one of a stator and a rotor, and a pin brake unit restricts rotational motion of any one of the rotor and the switching disc. Specifically, according to an embodiment of the present disclosure, a switching disc provides braking frictional force to a stator or a rotor, and a pin brake unit restricts the rotor or the switching disc.

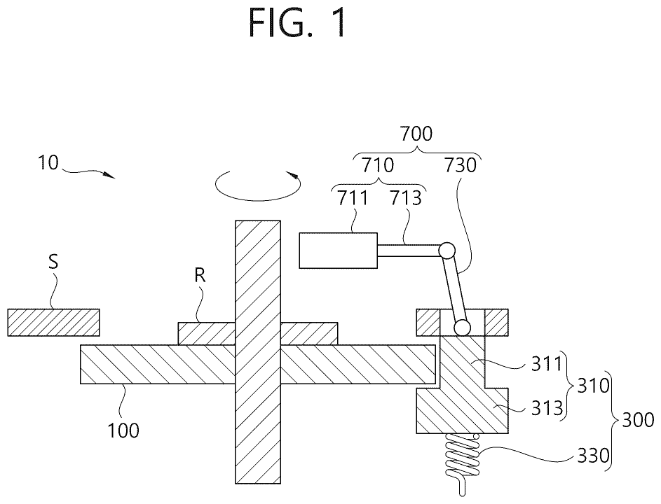

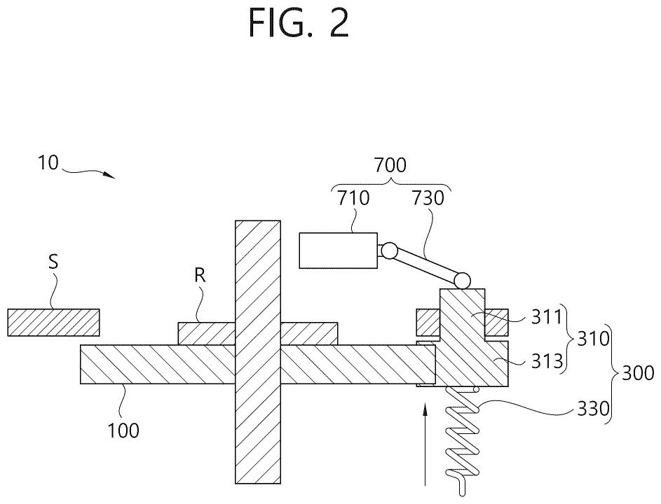

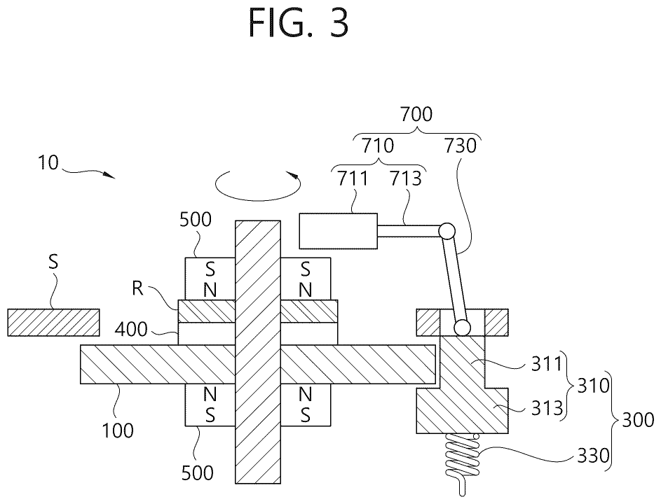

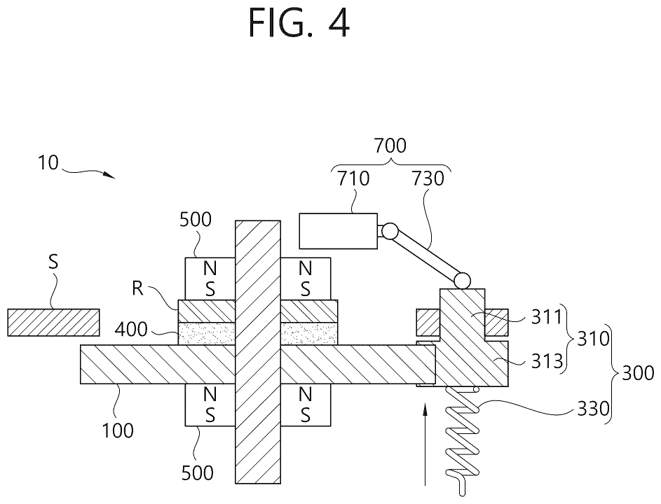

FIG. 1 is a first operational cross-sectional view of a brake assembly for a motor according to a first embodiment of the present disclosure, FIG. 2 is a second operational cross-sectional view of a brake assembly for a motor according to the first embodiment of the present disclosure, FIG. 3 is a first operational cross-sectional view of a brake assembly for a motor according to a second embodiment of the present disclosure, and FIG. 4 is a second operational cross-sectional view of a brake assembly for a motor according to the second embodiment of the present disclosure.

As shown in FIGS. 1 to 4, brake assemblies 10 for a motor according to the first and second embodiments of the present disclosure include a switching disc 100, a pin brake unit 300, and an actuator 700. Meanwhile, the brake assembly 10 for a motor according to the second embodiment of the present disclosure further includes a magneto-rheological fluid 400 and magnet units 500. The brake assembly 10 for a motor according to the first embodiment of the present disclosure generates mechanical braking frictional force, and the brake assembly 10 for a motor according to the second embodiment of the present disclosure generates brake torque due to a change in the viscosity the magneto-rheological fluid 400 together with the mechanical braking frictional force of the brake assembly 10 for a motor according to the first embodiment of the present disclosure.

The switching disc 100 rotates with the same rotational axis as the rotational axis of a rotor R. The switching disc 100 of the brake assemblies 10 for a motor according to the first and second embodiments of the present disclosure provides braking frictional force between the switching disc and the rotor R. Specifically, the switching disc 100 rotates in coupled relation with the rotor during rotational motion of the rotor R because it has predetermined frictional force at the contact area with the rotor R. The switching disc 100 provides braking frictional force in which friction increases at the contact area with the rotor R when its rotational motion is restricted by the pin brake unit 300.

The pin brake unit 300 is reciprocally moved in the rotational axis direction of the rotor R and the switching disc 100. The pin brake unit 300, as first and second embodiments of the present disclosure, restricts rotational motion of the switching disc 100. The pin brake unit 300 is selectively brought into contact with the switching disc 100 by operation of the actuator 700, depending on whether current is supplied to the actuator 700.

The pin brake unit 300 includes a pin brake 310 and an elastic member 330. The pin brake 310 is reciprocated between a contact position where it is brought into contact with the switching disc 100 when current supply to the actuator 700 is interrupted, and a contact release position where contact with the switching disc 100 is released when current is supplied to the actuator 700. The pin brake unit 300 includes a first pin brake 311 and a second pin brake 313 that have different cross-sectional areas, respectively. The first pin brake 311 is connected to the actuator 700 and is linearly moved by pressing force. When the first pin brake 311 is adjacent to the switching disc 100, it is positioned at the contact release position where the rotor R is rotated. In contrast, the second pin brake 313 is extended and disposed below the first pin brake 311, and has a cross-sectional area larger than that of the first pin brake 311. The second pin brake 313 is positioned at the contact position where it is brought into contact with the switching disc 100 when it is moved upward by the elastic force of the elastic member 330.

The elastic member 330 is disposed on one side of the pin brake 310 in the reciprocating movement direction of the pin brake 310, and provides elastic force to the pin brake 310 so that the pin brake 310 is moved from the contact release position to the contact position when current supply to the actuator 700 is interrupted. When the pressing force supplied from the actuator 700 to the pin brake 310 is released upon interruption of current supply, the pin brake 310 is moved upward, so the elastic member 330 provides elastic force to the pin brake 310 so that the switching disc 100 and the second brake 313 are brought into contact.

The actuator 700 is connected to the pin brake unit 300 and operates to selectively provide braking frictional force between the pin brake unit and any one of the stator S and the rotor R by the switching disc 100 depending on whether current is supplied. The actuator 700 in the first and second embodiments of the present invention operates so that the switching disc 100 and the pin brake unit 300 are selectively brought into contact. Specifically, the actuator 700 provides pressing force to the pin brake 310 so that the first pin brake 311 is moved adjacent to the side of the switching disc 100 when current is supplied, and releases the pressing force so that the switching disc 100 and the second pin brake 313 are brought into contact by the elastic member 330 when the current supply is interrupted.

The actuator, as an embodiment, includes a solenoid valve 710 that has a rod 713 and a valve body 711 accommodating the rod 713 and linearly moves the rod 713 with respect to the valve body 711 depending on whether current is supplied, and a link 730 that interconnects the pin brake unit and the rod 713 and supports the provision and release of pressing force to the pin brake unit 300 according to the linear movement of the rod 713 on the basis of whether current is supplied to the solenoid valve 710.

As shown in FIGS. 3 and 4, the brake assembly 10 for a motor according to the second embodiment of the present disclosure further includes a magneto-rheological fluid 400 and magnet units 500, along with the components of the first embodiment of the present disclosure. The magneto-rheological fluid 400 is disposed between the rotor R and the switching disc 100. As shown in FIG. 3, since when the rotor R is rotated, the magnet units 500 disposed on both sides of the magneto-rheological fluid 400 have the same polarity, a magnetic field is not applied, and accordingly, a change in viscosity of the magneto-rheological fluid 400 is limited. On the other hand, as shown in FIG. 4, when the rotational motion of the switching disc 100 is restricted by the pin brake unit 300, the magnet units 500 disposed on both sides of the magneto-rheological fluid 400 have different polarities, so a magnetic field is applied, and accordingly, the viscosity of the magneto-rheological fluid 400 changes and brake torque is generated.

The magnet units 500 are disposed on both sides with the magneto-rheological fluid 400 therebetween. The magnet units 500 disposed on both sides may use permanent magnets, and optionally, any one of them may use an electromagnet. The magnet units 500 selectively provide a magnetic field to the magneto-rheological fluid 400 depending on the position of the switching disc 100.

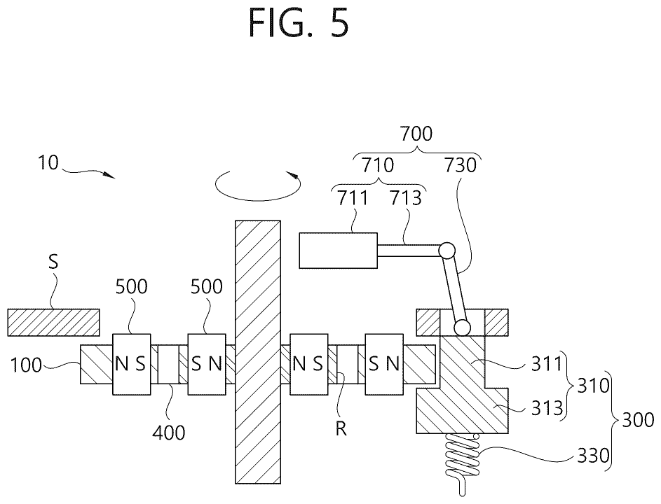

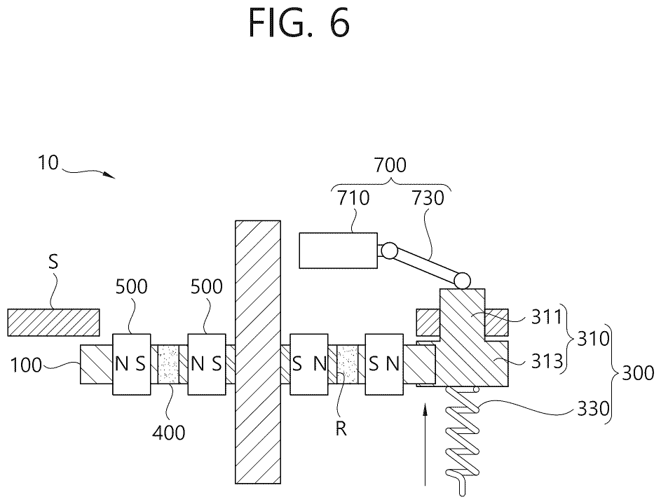

Next, FIG. 5 is a first operational cross-sectional view of a brake assembly for a motor according to a third embodiment of the present disclosure and FIG. 6 is a second operational cross-sectional view of a brake assembly for a motor according to the third embodiment of the present disclosure.

The brake assembly 10 for a motor according to the third embodiment of the present disclosure includes a switching disc 100, a pin brake unit 300, a magneto-rheological fluid 400, magnet units 500, and an actuator 700, which are the same components as those of the brake assembly 10 for a motor according to the second embodiment of the present disclosure. The switching disc 100 of the brake assembly 10 for a motor according to the third embodiment of the present disclosure is brought into contact with and released from the pin brake unit 310, and the actuator 700 operates so that the switching disc 100 and the pin brake unit 300 are selectively brought into contact.

The switching disc 100 of the brake assembly 10 for a motor according to the third embodiment of the present disclosure is disposed to surround the rotor R parallel to the rotational axis of the rotor R. Further, the magneto-rheological fluid 400 is disposed between the rotor R and the switching disc 100. A viscosity change of the magneto-rheological fluid 400 is limited when the magnet units 500 disposed with the magneto-rheological fluid 400 therebetween have the same polarity, which depends on their positions, as shown in FIG. 5. On the other hand, when the magnet units 500 disposed with the magneto-rheological fluid 400 therebetween have different polarities depending on their positions, as shown in FIG. 6, the viscosity of the magneto-rheological fluid 400 is changed by a magnetic field applied from the magnet units 500, whereby brake torque is generated.

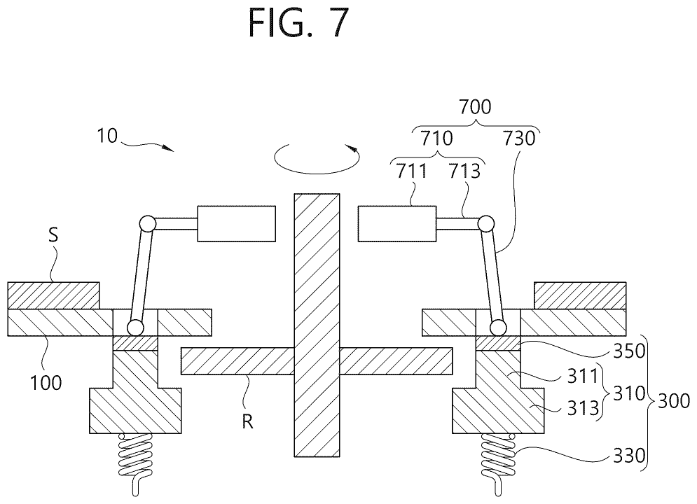

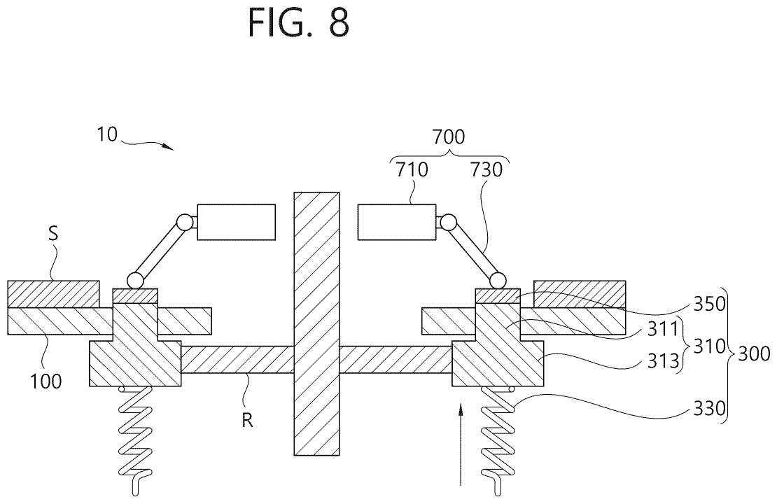

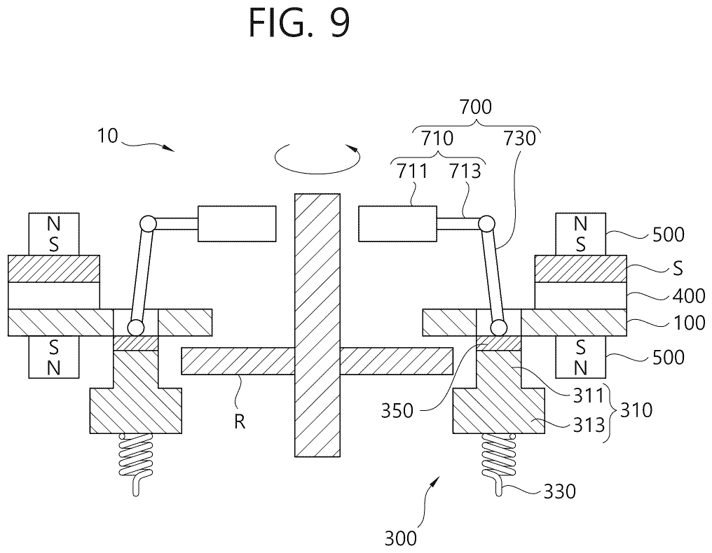

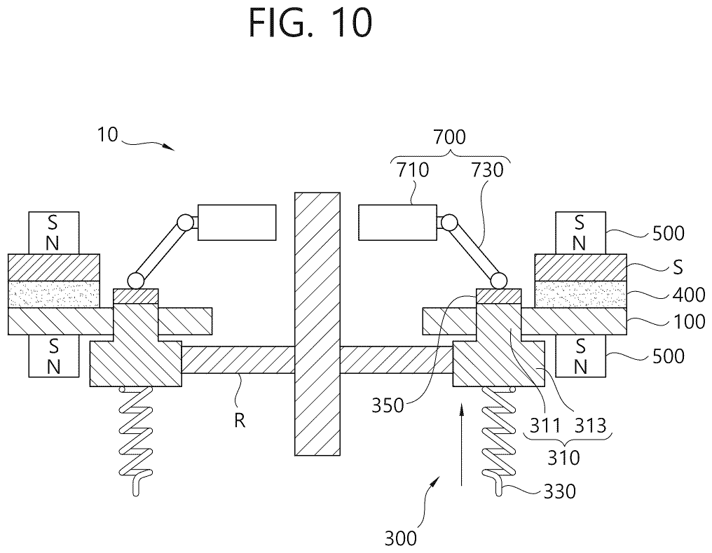

FIG. 7 is a first operational cross-sectional view of a brake assembly for a motor according to a fourth embodiment of the present disclosure, FIG. 8 is a second operational cross-sectional view of a brake assembly for a motor according to the fourth embodiment of the present disclosure, FIG. 9 is a first operational cross-sectional view of a brake assembly for a motor according to a fifth embodiment of the present disclosure, and FIG. 10 is a second operational cross-sectional view of a brake assembly for a motor according to the fifth embodiment of the present disclosure.

The brake assembly 10 for a motor according to the fourth embodiment of the present disclosure shown in FIGS. 7 and 8, similar to the brake assembly 10 for a motor according to the first embodiment of the present disclosure, includes a switching disc 100, a pin brake unit 300 and an actuator 700. Further, the brake assembly 10 for a motor according to the fifth embodiment of the present disclosure further includes a magneto-rheological fluid 400 and magnet units 500 in addition to the components of the brake assembly 10 for a motor according to the fourth embodiment of the present disclosure.

The switching disc 100 of the brake assembly 10 for a motor according to the fourth embodiment of the present disclosure generates braking frictional force between the switching disc and the stator S, unlike the first to third embodiments of the present disclosure. when current is supplied to the actuator 700, the switching disc 100 remains stationary, unlike the rotor R that is rotated. The switching disc 100 generates braking frictional force between the switching disc 100 and the stator S when the pin brake unit 300 is positioned at the contact position where the pin brake unit 300 is brought into contact with the rotor R. Specifically, when current supply to the actuator 700 is interrupted, a first pin brake 311 of the pin brake 310 is inserted into the switching disc 100, and the switching disc 100 is temporarily rotated in coupled relation with rotational motion of the rotor R due to the contact between the rotor R and the pin brake unit 300, thereby generating braking frictional force between the switching disc 100 and the stator S.

Here, at least two pin brake units 300 of the brake assemblies 10 for a motor according to the fourth and fifth embodiments of the present disclosure are disposed, and further include a stopper guide 350. The stopper guide 350 has a ring shape and is disposed between the actuator 700 and the pin brake 310. During coupled operation with rotational motion of the rotor R, when the switching disc 100 is rotated, the stopper guide 350 guides movement of the pin brake 310 and provides actuation of the actuator 700 to the pin brake 310.

The brake assembly for a motor 10 according to the fifth embodiment of the present disclosure further includes a magneto-rheological fluid 400 and magnet units 500. The magneto-rheological fluid 400 is disposed between the stator S and the switching disc 100, and the magnet unit 500 is disposed with the magneto-rheological fluid 400 therebetween. Since the detailed operation process has been described in the brake assemblies 10 for a motor according to the second to fourth embodiments of the present disclosure, a detailed description thereof is omitted below.

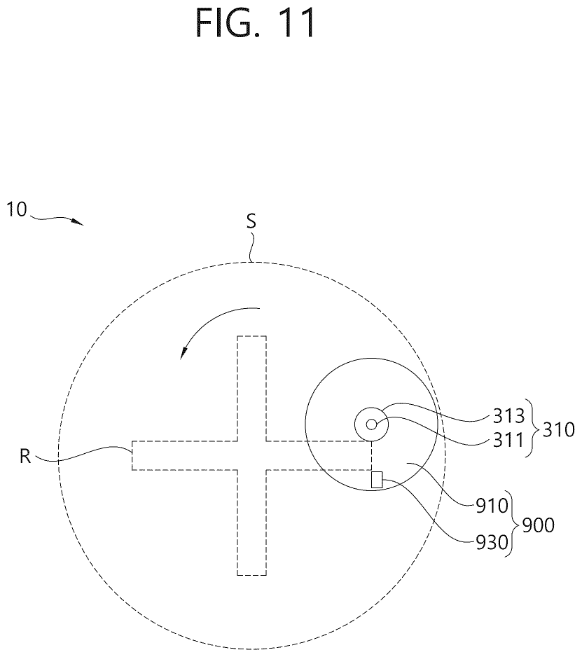

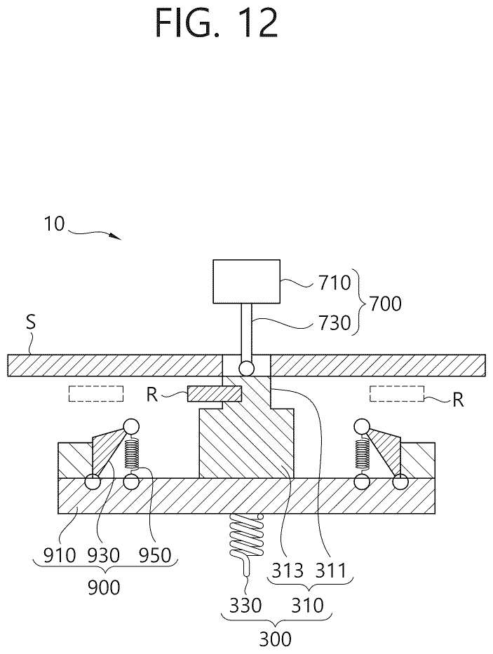

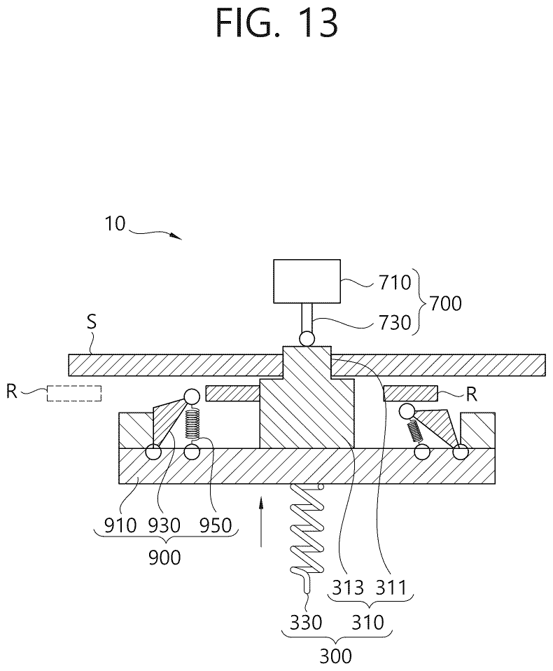

Finally, FIG. 11 is a plan view of a brake assembly for a motor according to a sixth embodiment of the present disclosure, FIG. 12 is a first operational cross-sectional view of a brake assembly for a motor according to the sixth embodiment of the present disclosure, and FIG. 13 is a second operational cross-sectional view of a brake assembly for a motor according to the sixth embodiment of the present disclosure.

The brake assembly for a motor according to the sixth embodiment of the present disclosure, as shown in FIGS. 11 to 13, includes a pin brake unit 300, an actuator 700, and a backlash restriction unit 900. That is, the brake assembly 10 for a motor according to the sixth embodiment of the present disclosure, unlike the brake assemblies 10 for a motor according to the first to fifth embodiments of the present disclosure, does not include the switching disc 100.

The pin brake unit 300 is disposed at the stator S and reciprocally moved between the contact position where contact with the rotor R is made and the contact release position where contact with the rotor R is released. The pin brake unit 300, similar to the first to fifth embodiments of the present disclosure, includes a pin brake 310 and an elastic member 330. Since the pin brake unit 300 was described in the first to fifth embodiments, detailed description thereof is omitted below.

The backlash restriction unit 900 is disposed under the pin brake unit 300 and restricts reverse rotational motion of the rotor when rotational motion of the rotor R is restricted by the pin brake unit 300. More specifically, referring to FIG. 11, the backlash restriction unit 900 restricts reverse rotational motion of the rotor R because, when the rotor R is rotated counterclockwise and brought into contact with the pin brake unit 300 in the rotational direction, reverse rotational motion of the rotor R may occur. The rotational motion of the rotor R can be more precisely restricted by the backlash restriction unit 900.

As an embodiment of the present disclosure, the backlash restriction unit 900 includes a body part 910, a backlash restriction part 930, and a backlash restriction part elastic member 950. The body part 910 is disposed under the pin brake unit 300 and is moved in coupled relation with movement of the pin brake unit 300. The backlash restriction part 930 is rotatably connected to the body part 910 and is brought into contact with the rotor R when the pin brake unit 300 is brought into contact the rotor R, thereby restricting the reverse rotational movement of the rotor R. Specifically, the backlash restriction part 930 is rotatably disposed on the body part 910, and is rotated to avoid interference with the rotor R in the rotational movement direction of the rotor R and is brought into contact with the rotor R to restrict reverse rotational movement of the rotor R when the rotor R and the pin brake unit 300 are brought into contact.

The backlash restriction part elastic member 950 connects the body part 910 and the backlash restriction part 930 to each other, and provides elastic force to the backlash restriction part 930 in the direction in which the backlash restriction part 930 is brought into contact with the rotor R, that is, to a position where reverse rotational motion of the rotor R is restricted.

Accordingly, by selectively coming into contact with any one of the rotor and the switching disc using the pin brake, braking friction force is generated between the rotor and the switching disc or between the stator and the switching disc, whereby it is possible to ensure the operational safety of the motor even when current supply is interrupted, such as during a power outage.

Further, since it is possible to generate brake torque that depends on a change in viscosity of a magneto-rheological fluid by further disposing the magneto-rheological fluid between the rotor and the switching disc or between the stator and the switching disc, it is possible to ensure operation safety of the motor even when current supply is interrupted, such as during a power outage.

In addition, since it is possible to accurately stop the rotor by disposing a backlash restriction unit that restricts rotation in the reverse direction of the rotational motion direction of the rotor when restricting rotational motion of the rotor by operating the pin brake unit, it is possible to improve the operational reliability of the motor.

Although exemplary embodiments of the present disclosure were described above with reference to the accompanying drawings, those skilled in the art would understand that the present disclosure may be implemented in various ways without changing the necessary features or the spirit of the prevent disclosure. Therefore, the embodiments described above are only examples and should not be construed as being limitative in all respects. The scope of the present disclosure is defined by the following claims rather than the above detailed description, and all of changes and modifications obtained from the meaning and range of claims and equivalent concepts should be construed as being included in the scope of the present disclosure.

[Project ID Number] 1415184238, [Project Number] 20019022, [Ministry] Ministry of Trade, Industry and Energy, [Research Management Agency] Korea Institute for Advancement of Technology, [Research Program] Industrial Technology Innovation Program (Material and Component Technology Development Project), [Research Project Title] Development of Customized Core Force Torque Sensor Technology for Service Robots, [Contribution Rate] 1/1, [Project Performing Organization] AIDIN Robotics, [Research Period] Aug. 1, 2022~Dec. 31, 2024

1. A brake assembly for a motor having a stator and a rotor, the brake assembly comprising:
a switching disc that is rotated with the same rotational axis as a rotational axis of the rotor and selectively provides braking frictional force between the switching disc and any one of the stator and the rotor;
a pin brake unit that is reciprocally moved in the rotational axis direction of the rotor and the switching disc and restricts rotational motion of any one of the rotor and the switching disc; and
an actuator that is connected to the pin brake unit and is operated to selectively provide braking frictional force between the pin brake unit and any one of the stator and the rotor by the switching disc depending on whether current is supplied.

2. The brake assembly of claim 1, further comprising:
a magneto-rheological fluid (MR fluid) that is disposed between the rotor and the switching disc or between the stator and the switching disc, and selectively varies in viscosity to generate brake torque that stops rotational motion of the rotor; and
magnet units that are respectively disposed on both sides with the magneto-rheological fluid therebetween, have different polarities when rotational motion of the rotor is restricted, and generate a magnetic field in the magneto-rheological fluid to induce a change in viscosity of the magneto-rheological fluid.

3. The brake assembly of claim 1, wherein the pin brake unit includes:
a pin brake that is reciprocally moved between a contact position where the pin brake is brought into contact with any one of the rotor and the switching disc when current supply to the actuator is interrupted and a contact release position where contact with any one of the rotor and the switching disc is released when current is supplied to the actuator; and
an elastic member that disposed on one side of the pin brake in a reciprocating movement direction of the pin brake and provides elastic force to the pin brake so that the pin brake is moved from the contact release position to the contact position when current supply to the actuator is interrupted.

4. The brake assembly of claim 3, wherein the pin brake unit is disposed at the stator and reciprocally moved between the contact position where contact with the switching disc is made and the contact release position where contact is released, by operation of the actuator.

5. The brake assembly of claim 4, wherein rotational motion of the switching disc is restricted at the contact position, so braking frictional force between the rotor and the switching disc increases to stop the rotor.

6. The brake assembly of claim 3, wherein the pin brake unit is disposed at the switching disc and reciprocally moved between the contact position where contact with the rotor is made and the contact release position where contact is released, by operation of the actuator.

7. The brake assembly of claim 6, wherein braking frictional force between the stator and the switching disc is increased to stop the rotor during coupled rotational motion of the rotor and the switching disc at the contact position.

8. The brake assembly of claim 7, wherein the switching disc is stopped at the contact release position and rotated in coupled relation with the rotor for a predetermined time at the contact position.

9. The brake assembly of claim 7, wherein at least two pin brake units are disposed, and
the pin brake units further include a stopper guide that has a ring shape, is disposed between the actuator and the pin brake, and guides movement of the pin brake and provides pressing force due to operation of the actuator to the pin brake when the switching disc is rotated, during coupled operation with rotational motion of the rotor.

10. A brake assembly for a motor having a stator and a rotor, the brake assembly comprising:
a pin brake unit that is disposed at the stator and selectively restricts rotational motion of the rotor by reciprocally moving in a rotational axis direction of the rotor;
an actuator that is connected to the pin brake unit and selectively provides driving force to the pin brake so that the rotor and the pin brake unit are selectively brought into contact depending on whether current is supplied; and
a backlash restriction unit that is disposed under the pin brake unit, and restricts reverse rotational motion of the rotor when rotational motion of the rotor is restricted by the pin brake unit.

11. The brake assembly of claim 10, wherein the rotor is arranged with a plurality of blades, and the pin brake unit and the backlash restriction unit are respectively brought into contact with both sides of the blades, thereby restricting rotational motion of the rotor in both directions.

12. The brake assembly of claim 10, wherein the pin brake unit includes:
a pin brake that is reciprocally moved between a contact position where the pin brake is brought into contact with the rotor when current supply to the actuator is interrupted and a contact release position where contact with the rotor is released when current is supplied to the actuator; and
an elastic member that disposed on one side of the pin brake in a reciprocating movement direction of the pin brake and provides elastic force for movement from the contact release position of the pin brake to the contact position when current supply to the actuator is interrupted.

13. The brake assembly of claim 10, wherein the backlash restriction unit includes:
a body part that is disposed under the pin brake unit and moved in coupled relation with movement of the pin brake unit;
a backlash restriction part that is rotatably connected to the body part and is brought into contact with the rotor when the pin brake unit is brought into contact the rotor, thereby restricting reverse rotational movement of the rotor; and
a backlash restriction part elastic member that connects the body part and the backlash restriction part to each other and provides elastic force to the backlash restriction part so that the backlash restriction part is rotated in a direction in which the backlash restriction part is brought into contact with the rotor.
